(19) United States
(12) Patent Application Publication
(10) Pub. No.: US 2009/0229613 A1
(43) Pub. Date: Sep. 17, 2009

(54) Protective garment adapted for self-contained breathing apparatus

(76) Inventors: William L. Grilliot, Dayton, OH (US); Mary I. Grilliot, Dayton, OH (US); Patricia K. Waters, Tipp City, OH (US); William L. Grilliot, JR., Dayton, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/075,687

(22) Filed: Mar. 13, 2008

(51) Int. Cl. A62B 7/02; A62B 17/00

(52) U.S. Cl. 128/205.22; 2/81

(57) ABSTRACT

A system (20) is provided for a firefighter or other emergency worker and includes a protective coat (10) and a self-contained breathing apparatus (12). The self-contained breathing apparatus includes a regulator (14) connected by a high pressure hose (16) to an oxygen/air tank (18) that is carried by the coat (10).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to protective garments worn by firefighters and other emergency workers and to self-contained breathing apparatus (SCBA) that are used by firefighters and other emergency workers.

### BACKGROUND OF THE INVENTION

It is common for firefighters and other emergency workers to wear a self-contained breathing apparatus (SCBA) having an air tank that is carried on the back of a firefighter by a framework, a harness that will typically include shoulder straps, and a waist strap worn over the coat of their turnout gear. While such set-ups have performed well for their intended function, there is always room for improvement. For example, one problem that can occasionally occur is that the harness can snag or otherwise become entangled with objects during an emergency. Another problem is that the framework, harness, and waist strap add to the weight that must be carried by the firefighter.

### SUMMARY OF THE INVENTION

In accordance with one feature of the invention, a protective coat and self-contained breathing apparatus system is provided for a firefighter or other emergency worker. The system includes an oxygen/air tank, a regulator, a high pressure hose connected to the tank and the regulator to provide a flow of oxygen/air from the tank to the regulator, and a garment having an outer shell having a torso covering portion with a back and a front, a pair of sleeves extending from the torso covering portion, and a pocket located in the back of the torso covering portion and carrying the oxygen/air tank.

As one feature, the high pressure hose extends through an opening from an interior of the pocket and an interior side of the outer shell.

In one feature, the high pressure hose extends through a port in the front of the torso covering portion from the interior side of the outer shell to an exterior of the outer shell.

According to one feature, the system further includes a low pressure line extending from the regulator to inside of the outer shell to direct expelled air from the regulator to inside of the outer shell.

As a further feature, the low pressure line extends through the second opening.

In one feature, the high pressure line extends inside of the low pressure line from inside of the outer shell to the regulator.

In accordance with one feature, the pocket is located on the interior side of the outer shell.

According to one feature, the pocket is located on the exterior side of the outer shell.

As one feature, the pocket includes two longitudinal gussets spaced on opposite sides of the pocket, the gussets configured to allow the pocket to lay flat along the back of the coat with the tank removed from the pocket.

In one feature, one of the gussets has an opening to the pocket provided in the gusset, the opening sized to allow the tank to be loaded into the pocket, and further including a closure element in the gusset to provide a closed state and an open state for the opening.

As one feature, the closure element is a zipper extending along the one of the gussets.

According to one feature, the tank has a flattened cross-section.

In one feature, the coat further includes a liner and the high pressure hose extends between the outer shell and the liner.

In accordance with one feature of the invention, a protective coat is provided for use with a self-contained breathing apparatus system for a firefighter or other emergency worker. The coat includes an outer shell having a torso covering portion with a back and a front, a pair of sleeves extending from the torso covering portion, and a pocket fixed to the outer shell and adapted to carry an oxygen/air tank of the self-contained breathing apparatus. An opening extends between an interior of the pocket and an interior side of the outer shell to allow passage of a high pressure hose of the self-contained breathing apparatus, and a port is provided in the torso covering portion and is adapted to allow the high pressure hose to pass from the inside of the outer shell to an exterior of the outer shell for connection with a regulator of the self-containing breathing apparatus.

As one feature, the pocket is located on the torso portion.

In accordance with one feature of the invention, a protective coat is provided for use with self-contained breathing apparatus system for a firefighter or other emergency worker. The coat includes an outer shell having a torso covering portion with a back and a front, a pair of sleeves extending from the torso covering portion, and a pocket adapted to carry an oxygen/air tank of the self-contained breathing apparatus. The pocket includes two longitudinal gussets spaced on opposite sides of the pocket, the gussets configured to allow the pocket to lay flat against the outer shell with the tank removed from the pocket and to expand outwardly with the tank inserted in the pocket.

In one feature, one of the gussets has an opening to the pocket sized to allow the tank to be inserted into and removed from the pocket, and further comprising a closure element in the gusset to provide a closed state and an open state for the opening.

As one feature, the closure element is a zipper extending along the one of the gussets.

Other objects, features, and advantages of the invention will become apparent from a review of the entire specification, including the appended claims and drawings.

### BRIEF DESCRIPTION OF THE DRAWINGS

FIG. 1 is a perspective view from the side of a fireman or other emergency worker wearing a protective coat and SCBA system embodying the present invention;

FIG. 2 is a partial, section view generally taken along line 2-2 in FIG. 1;

FIG. 3 is an elevation view of an oxygen/air tank of the SCBA of FIG. 1;

FIG. 4 is a side view of the oxygen/air tank of FIG. 3;

FIG. 5 is a perspective view from the side of a fireman or other emergency worker wearing another protective coat and SCBA system embodying the present invention;

FIGS. 6 and 7 are partial, perspective views from the side of a fireman or other emergency worker wearing another version of a protective coat and SCBA system embodying the present invention, with FIG. 6 showing the coat in one state and FIG. 7 showing the coat in another state;

FIG. 8 is a back view of a protective coat embodying the present invention;

FIGS. 9A and 9B are section views taken along line 9-9 in FIG. 8 showing the protective coat in different states.

### DETAILED DESCRIPTION OF THE PREFERRED EMBODIMENTS

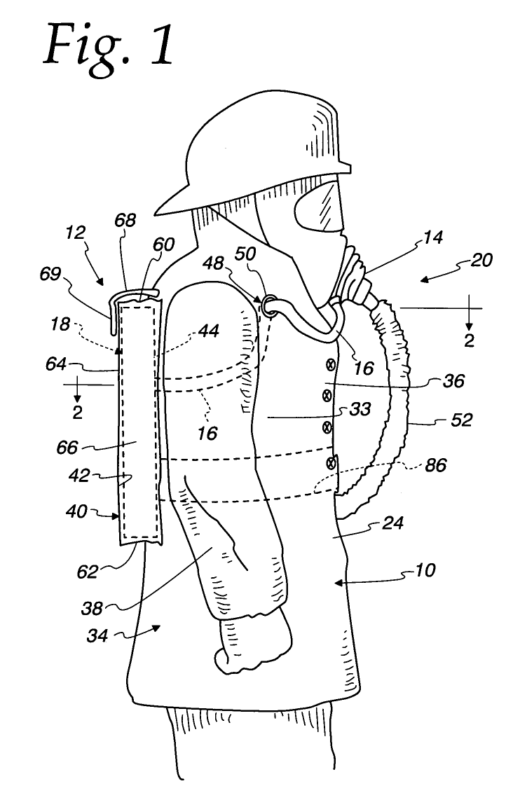

With reference to FIG. 1, a firefighter or other emergency worker is shown wearing a protective garment in the form of a protective coat 10, and a self-contained breathing apparatus (SCBA) 12 that includes a regulator 14 connected by a high pressure hose 16 to an oxygen/air tank 18 that is carried on the back of the firefighter by the coat 10. Together, the coat 10 and the SCBA 12 form a system 20 that allows a firefighter or other emergency worker to perform in hazardous environments. Except as described herein, the coat 10 may be substantially similar to prior garments and coats designed for firefighters and rescue workers, such as those manufactured and sold by Morning Pride Manufacturing, Inc. of Dayton, Ohio.

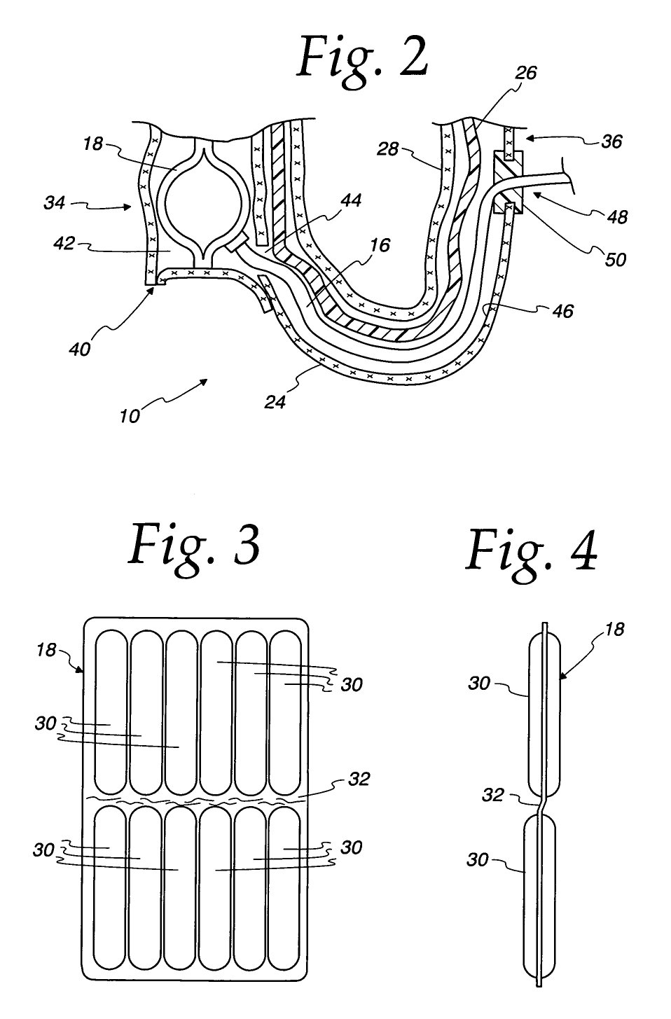

As best seen in FIG. 2, the coat 10 is preferably a multi-layered construction consisting of an outer shell 24, a moisture barrier and/or chemical barrier liner 26, and optionally, but preferred, an thermal insulating barrier liner 28. Each of the layers 24, 26 and 28 can be made from suitable fabrics for each of their particular functions, many of which are known. For example, the outer shell 24 can be made from any suitable fire resistant, thermal resistant and/or wear resistant (i.e., resistant to cuts, snags, tears, and abrasions) material, some examples of which include Kevlar®, Nomex®, Basofil, PBI (polybenzimidazole), and PBO (poly(p-phenylene-benzobisoxazole)) materials. The moisture barrier liner 26 can be made of any suitable material that will be highly resistant to passage of liquid, particularly liquid water, through the material, some examples of which include Crosstech® material (breathable) or Neoprin® (non-breathable). Furthermore, if chemical resistance is desired, the liner 26 can be made from a suitable material, such as a material supplied by W. L. Gore & Associates, Inc. under the CHEMPAK® trademark. The thermal insulative liner 28 can be made of a suitable thermal insulating material or construction, such as nonwoven batting, closed cell foam, and/or Basofil/Aramid batting sandwiched between face layers of a suitable breathable fabric.

As best seen in FIGS. 3 and 4, the tank 18 is preferably of a new type that is recently being developed to have a lower profile, with a flattened cross-section in comparison to the more conventional cylindrical oxygen/air tanks. In the illustrated embodiment, the tank 18 has two rows of interconnected, vertically extending, semi-cylindrical oxygen/air compartments or bladders 30 arranged, with a somewhat flexible “hinge” portion 32 that allows the tank to partially conform to and/or bend with the wearer's body. It should be appreciated that while a particular embodiment of the tank 18 is shown, in some applications it will be desirable to use other forms and types of oxygen/air tanks 18.

With reference to FIG. 1, the outer shell 24 has a torso covering portion 33 with a back 34 and a front 36, a pair of sleeves 38 (only one shown in FIG. 1) extending from the torso covering portion 32, and a pocket 40 that carries the oxygen/air tank 18, thereby replacing the harness that has conventionally been used in connection with SCBA's. As best seen in FIG. 2, the interior 42 of the pocket 40 is preferably configured to somewhat closely conform to the shape of the tank 18, which as previously discussed, preferably has a flattened cross-section such as shown in FIGS. 3 and 4.

As best seen in FIG. 2, the high pressure hose 16 extends through an opening 44 from the interior 42 of the pocket 40 to an interior side 46 of the outer shell 24, extends on the inside of the outer shell 24 from the back 34 to the front 36, and exits through a port 48 to the exterior of the outer shell 24 for connection with the regulator 14. Preferably, a suitable connector or gasket, shown generally at 50, is provided in the port 48 to provide a sealed pass through for the hose 16. Another embodiment of the system is shown in FIG. 5 wherein a low pressure hose or line 52 extends from an exhalation valve in the regulator 14 to the inside of the outer shell 24 via the port 48 to direct expelled air from the regulator 14 to the inside of the outer shell 24 and create a positive pressure therein. In this regard, if the either or both of the liners 26 and 28 are used, the line 52 can be configure to direct the air either to the inside of either liner 26, 28 if desirable for a particular application. As illustrated, it is preferred in this embodiment for the high pressure hose 16 to extend inside of the low pressure hose 52 from the inside of the outer shell 24 to the regulator 14. This provides a system 20 wherein there is only one SCBA line or hose exposed on the exterior of the coat 10.

The pocket 40 can be located on exterior side of the outer shell 24, as shown in FIG. 1, or on the interior side 46 of the outer shell 24, as shown in FIG. 5. As seen in FIG. 1, the pocket 40 includes an opening or mouth 60, a bottom portion 62, a main body panel 64 defining the back of the pocket 40, and a pair of side portions 66 (only one shown in FIG. 1 on either lateral side of the panel 64, with a closure or flap 68 to cover the mouth 60, The pocket components 62, 66 and 68 are sewn, bonding or otherwise suitably fixed to the exterior of the outer shell 24, and the panel 64 is sewn, bonded, or otherwise suitably fixed to the components 62 and 66. The mouth 60 is sized to allow the tank 18 to be inserted into and removed from the interior 42 of the pocket 40, and the flap 68 preferably includes a suitable closure element 69, such as mating hook and loop members, buttons, or snap fasteners, for releasable retention of the flap 68 in a closed position covering the mouth 60. The construction of FIG. 1 is replicated on the inside of the outer shell 24 in the embodiment of FIG. 5, with the components 62 and 66 being sewn, bonded, or otherwise suitably fixed to the interior side 46 of the outer shell 24, the mouth 60 being provided as an opening passing through the outer shell 24, and the flap 68 being sewn, bonded or otherwise suitably fixed to the exterior of the outer shell 24.

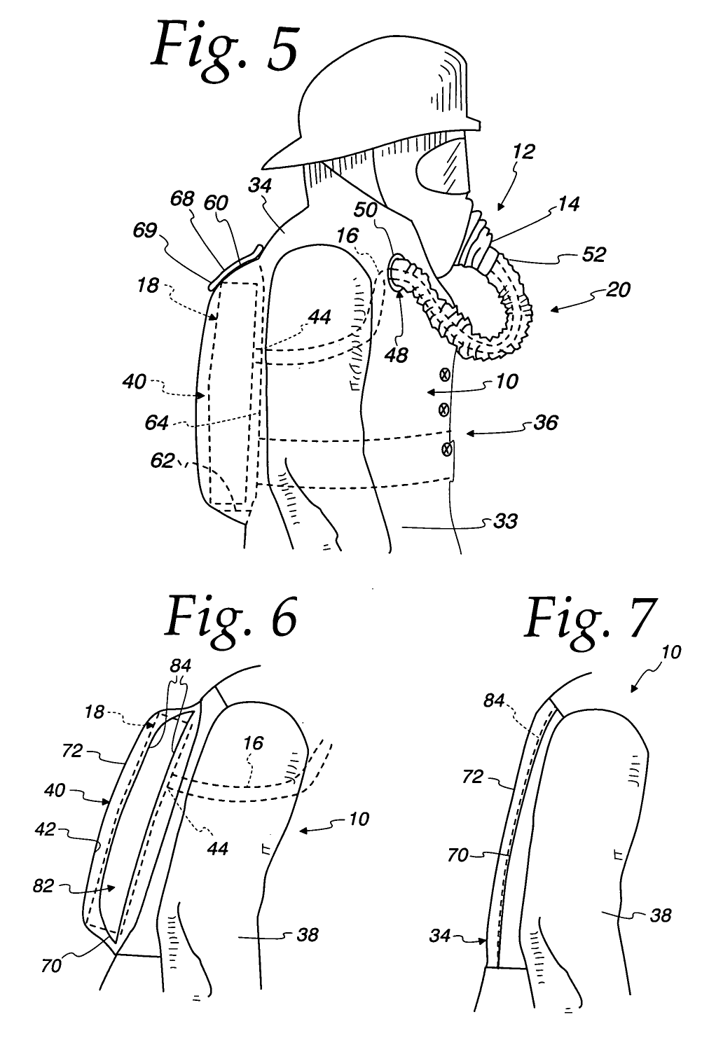

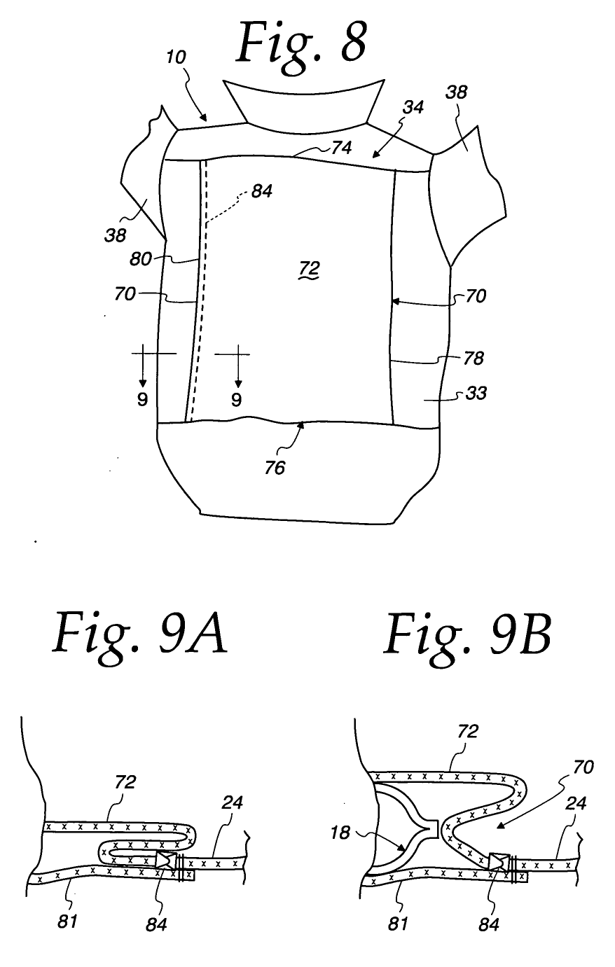

As shown in FIGS. 6-10, in another embodiment of the coat 10, the pocket 40 includes two longitudinal gussets 70 located on opposite lateral sides of the pocket 40, with the gussets 70 configured to allow the pocket 40 to lay flat along the back 34 of the coat 10 when the tank 18 is removed from the pocket 40, as shown in FIGS. 7 and 9A, but to expand outwardly when the tank 18 is carried in the pocket 40, as shown in FIGS. 6 and 9B. Preferably, the pocket 40 includes a main panel 72 having its top and bottom edges 74 and 76 sewn, bonded otherwise suitable fixed to the outer shell 24, as best seen in FIG. 8, and with its side edges 78 and 80 being folded to form the gussets 70, as best seen in FIGS. 8 and 9A, before being sewn, bonded, or otherwise suitably fixed to the outer shell 24. As best seen in FIGS. 9A and 9B, an interior panel 81 can be provided opposite the panel 72 to enclose the interior of the pocket 40, or the material of the outer shell can be extended across the pocket 40 from one gusset 70 to the other to enclose the interior of the pocket 40. Preferably, one of the gussets 70 has an opening or mouth 82 sized for insertion and removal of the tank 18 to and from the interior 42 of the pocket 40, with a suitable closure element, such as a zipper 84 extending along the gusset 70 to provide the opening 82 with a closed state for retaining the tank 18 in the pocket 40 and an open state for allowing insertion and removal of the tank 18.

As best seen in FIG. 1, in some applications it might be desirable to include a belt 86 at the waist or elsewhere, either on the interior of the outer shell 24 as shown, or on the exterior of the outer shell 24, to help support and/or secure the tank 18 to the wearer.

It should be understood that while several embodiments of the pocket have been illustrated and described herein, other suitable constructions may be utilized according to the invention to carry the tank 18. In this regard, it should further be understood that depending on the specific size and configuration of the tank 18, it may be desirable to locate the pocket 40 somewhere other than at the back 34, such as for example, at the front 36 or on one of the arm portions 38. It should also be understood that while it is preferred that the high pressure hose 16 extend from the tank 18 through the inside of the outer shell 24, in some applications it may be desirable to for the hose 16 to extend directly to the exterior from the pocket 40 and then extend onward over the exterior to connect with the regulator 14. It should further be understood that the configuration of the hoses 16 and 52 shown in FIGS. 1 and 5 are compatible with any of the pocket 40 and coat 10 embodiments described herein.

It should be appreciated that the disclosed embodiments of the system 20 can provide a number of advantages. For example, by carrying the tank 18 with the outer shell 24, the need for a conventional harness is eliminated together with the potential for snagging such a harness on an object during an emergency. The risk for such snagging can be further reduced by extending the hose 16 from the tank 18 through the inside of the outer shell 24, and even further reduced by extending the hose 16 inside of the hose 52. Additionally, the elimination of the harness can reduce the compression of the underlying garment(s), thereby improving the insulation performance of the garment and reducing the wear of the garments. Further more, interference with reflectors and other visual indicia on the exterior of the coat can be minimized with the elimination of the harness and/or reduction in the amount of external hose runs and/or enclosing the oxygen/air tank 18 in a pocket of the coat.

1. A protective coat and self-contained breathing apparatus system for a firefighter or other emergency worker, the system comprising:
an oxygen/air tank;
a regulator;
a high pressure hose connected to the tank and the regulator to provide a flow of oxygen/air from the tank to the regulator;
an outer shell having a torso covering portion with a back and a front, a pair of sleeves extending from the torso covering portion, and a pocket carrying the oxygen/air tank.

2. The system of claim 1 wherein the high pressure hose extends through an opening from an interior of the pocket and an interior side of the outer shell.

3. The system of claim 2 wherein the high pressure hose extends through a port in the front of the torso covering portion from the interior side of the outer shell to an exterior of the outer shell.

4. The system of claim 3 further comprising a low pressure line extending from the regulator to inside of the outer shell to direct expelled air from the regulator to inside of the outer shell.

5. The system of claim 4 wherein the low pressure line extends through the port.

6. The system of claim 5 wherein the high pressure line extends inside of the low pressure line from inside of the outer shell to the regulator.

7. The system of claim 1 wherein the pocket is located on the interior side of the outer shell.

8. The system of claim 1 wherein the pocket is located on the exterior side of the outer shell.

9. The system of claim 1 wherein the pocket comprises two longitudinal gussets spaced on opposite sides of the pocket, the gussets configured to allow the pocket to lay flat along the back of the coat with the tank removed from the pocket.

10. The system of claim 9 wherein one of the gussets has an opening to the pocket is provided in the gusset, the opening sized to allow the tank to be loaded into the pocket, and further comprising a closure element in the gusset to provide a closed state and an open state for the opening.

11. The system of claim 10 wherein the closure element is a zipper extending along the one of the gussets.

12. The system of claim 1 wherein the tank has a flattened cross-section.

13. The system of claim 1 wherein the coat further comprises a liner and the high pressure hose extends between the outer shell and the liner.

14. The system of claim 1 wherein the pocket is located in the back of the torso covering portion.

15. A protective coat for use with a self-contained breathing apparatus system for a firefighter or other emergency worker, the coat comprising:
an outer shell having a torso covering portion with a back and a front;
a pair of sleeves extending from the torso covering portion; and
a pocket fixed to the outer shell and adapted to carry an oxygen/air tank of the self-contained breathing apparatus, an opening extending between an interior of the pocket and an interior side of the outer shell to allow passage of a high pressure hose of the self-contained breathing apparatus, and a port in the torso covering portion adapted to allow the high pressure hose to pass from the inside of the outer shell to an exterior of the outer shell for connection with a regulator of the self-containing breathing apparatus.

16. The protective coat of claim 15 wherein the pocket is located on the torso portion.

17. A protective coat for use with self-contained breathing apparatus system for a firefighter or other emergency worker, the coat comprising:
an outer shell having a torso covering portion with a back and a front;
a pair of sleeves extending from the torso covering portion; and
a pocket adapted to carry an oxygen/air tank of the self-contained breathing apparatus, the pocket including two longitudinal gussets spaced on opposite sides of the pocket, the gussets configured to allow the pocket to lay flat against the outer shell with the tank removed from the pocket and to expand outwardly with the tank inserted in the pocket.

18. The protective coat of claim 17 wherein one of the gussets has an opening to the pocket sized to allow the tank to be inserted into and removed from the pocket, and further comprising a closure element in the gusset to provide a closed state and an open state for the opening.

19. The protective coat of claim 18 wherein the closure element is a zipper extending along the one of the gussets.

20. The protective coat of claim 17 wherein the pocket is located in the torso portion.
